(19) United States
(12) Patent Application Publication
(10) Pub. No.: US 2011/0301004 A1
(43) Pub. Date: Dec. 8, 2011

(54) ROLLING DEVICE

(76) Inventor: Chao-Jen LIN, Taipei (TW)

(21) Appl. No.: 13/155,545

(22) Filed: Jun. 8, 2011

(30) Foreign Application Priority Data
Jun. 8, 2010 (TW) 99118561

(51) Int. Cl. F16C 13/00

(52) U.S. Cl. 492/49

(57) ABSTRACT

A rolling device of utilizing flexible material, such as a soft piece, a tap, a plastic piece, a cardboard, a metal sheet, to roll a flexible thin component, such as a soft piece, a paper, a plastic piece, a metal sheet, a cloth, so as to inject the flexible thin component into the rolling device or to eject the flexible thin component out of the rolling device.

### BACKGROUND OF THE INVENTION

1. Field of the Invention

The present invention relates to a rolling device, and more particularly, to a rolling device of utilizing a tape, a plastic piece, a cardboard or a metal sheet to roll up a soft piece, a paper, a plastic piece or a cloth.

2. Description of the Prior Art

A rolling device is disclosed in TW patent application No. 94205453. Please refer to its figures. A rolling device of the TW patent utilizes a scrolling spring to roll up the paper disposed inside a pen. The rolling device includes a tube, a spindle, a protruding portion, a scrolling spring, a flexible thin component and a bottom covering. A first end of the scrolling spring is fixed on the spindle for surrounding the spindle and ending at a second end. A first end of the flexible thin component connects to a second end of the scrolling spring and surrounds the scrolling spring via the spindle for forming the spindle-flexible thin component set. The spindle-flexible thin component set is disposed on the tube and an end of the spindle protrudes out of the tube for forming a spindle protruding portion, and the bottom covering is covered and puts it inside a casing. After, a rotary component is disposed on the spindle protruding portion for forming a flexible thin component device, so as to drive the flexible thin component by rotating the spindle protruding portion, so that the flexible thin component can be rolled in or rolled out the casing of the flexible thin component device. Finally, the spindle-flexible thin component set device is disposed inside the tube for forming the pen having the rolling device.

Deformation of a curvature radius of the scrolling spring of the conventional rolling device is hard to be controlled, and the force applied on an inner side of the flexible thin component is unstable due to various contacts between the spindle and the flexible thin component. Further, unstable force application happens by friction between different areas of the scrolling spring when the flexible thin component is rotated by the scrolling spring. Therefore, because the scrolling spring surrounds the flexible thin component over and over, the force applied on the inner side of the flexible thin component is unstable in the conventional rolling device, which results the rolling invalidation of the flexible thin component and unstable yield rate. Design of a rolling device having stable function of the scrolling spring is an important issue of the mechanical industry.

### SUMMARY OF THE INVENTION

The present invention provides a rolling device of utilizing a tape, a plastic piece, a cardboard or a metal sheet to roll up a soft piece, a paper, a plastic piece or a cloth. The rolling device includes a spindle, and the spindle is a pillar component. The rolling device further includes a casing whereinside an accommodating space is formed, the spindle is disposed inside the casing, an end of the spindle is exposed out of the casing, and an opening is formed on the casing, so that a flexible thin component injects into and ejects out of the casing via the opening. The rolling device further includes a flexible recovering component, an end of the flexible recovering component is fixed on the spindle, the other end of the flexible recovering component is fixed on the flexible thin component, and the flexible recovering component has a resilient coefficient for recovering, so that an exposed part of the curved flexible thin component contacts an inner surface of the casing when the flexible thin component is curved and surrounds curvature radius of the spindle. The rolling device further includes a rotary component externally disposed on a top of the casing with the spindle and connecting to the end of the spindle, so as to rotate the spindle for injecting into or ejecting out of the flexible thin component.

According to the claimed invention, the flexible recovering component is a resilient component, such as a metal thin piece, and a length of the resilient component is smaller than a periphery of the spindle, and the resilient component is a metal sheet for preventing unstable force application due to friction between different parts of the resilient component. The present invention can improve drawbacks of a conventional rolling device, such as annulment of rolling movement. In addition, manufacturing cost and material cost of the present invention are economized according to the length of the resilient component of the new rolling device.

According to the claimed invention, a rolling device includes a spindle, and the spindle being a pillar component. The rolling device further includes a casing whereinside an accommodating space is formed, and the spindle is disposed inside the casing. An end of the spindle is exposed out of the casing, and an opening is formed on the casing so that a flexible thin component injects into and ejects out of the casing via the opening. The rolling device further includes a flexible recovering component. A first end of the flexible recovering component is fixed on the spindle, and a second end of the flexible recovering component is fixed on the flexible thin component. The flexible recovering component has a curved recovering coefficient for transmitting a pulling force or a pushing force from the first end to the second end. The flexible recovering component is pushed without deformation according to the minimize curved recovering coefficient, and the curved recovering coefficient is greater than the minimize curved recovering coefficient which results the pulling force or the pulling force dispersing on a surface of the flexible recovering component uniformly, so as to generate uniform static friction and uniform kinetic friction between the flexible recovering component and the flexible thin component, and the uniform static friction and the uniform kinetic friction are smaller or equal to the pulling force and the pushing force. The flexible recovering component is composed of a group consisting of a tape, a soft piece, a plastic piece or the cardboard. The rolling device further includes a rotary component externally disposed on a top of the casing with the spindle and connecting to the end of the spindle so as to rotate the spindle for injecting into or ejecting out of the flexible thin component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a flexible recovering component-spindle mechanism according to an embodiment of the present invention.

FIG. 2A is a diagram of a flexible thin component according to the embodiment of the present invention.

FIG. 2B is a diagram of a flexible thin component-spindle mechanism according to the embodiment of the present invention.

FIG. 3 is an exploded diagram of a rolling device according to the embodiment of the present invention.

FIG. 4 is an assembly diagram of a rolling device according to the embodiment of the present invention.

FIG. 5 is a diagram of a pen having the rolling device according to the embodiment of the present invention.

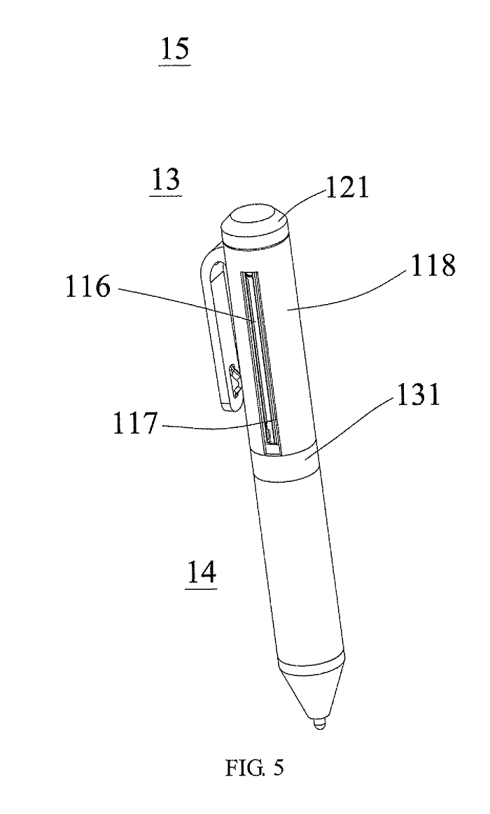

FIG. 6 is a side view of the rolling device according to the embodiment of the present invention.

FIG. 7 is a diagram of the rolling device according to the other embodiment of the present invention.

### DETAILED DESCRIPTION

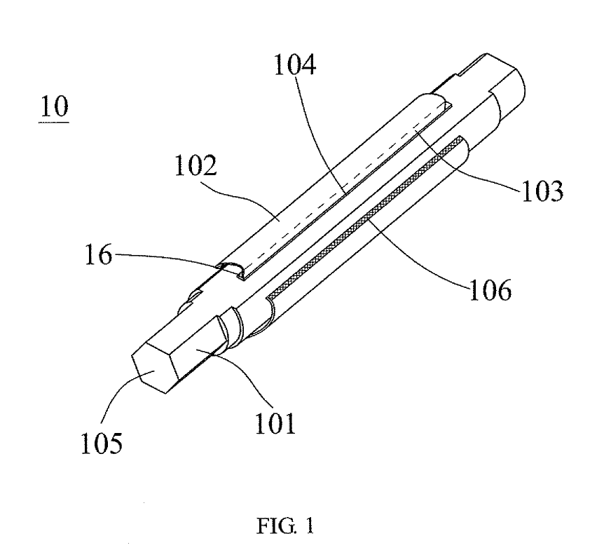

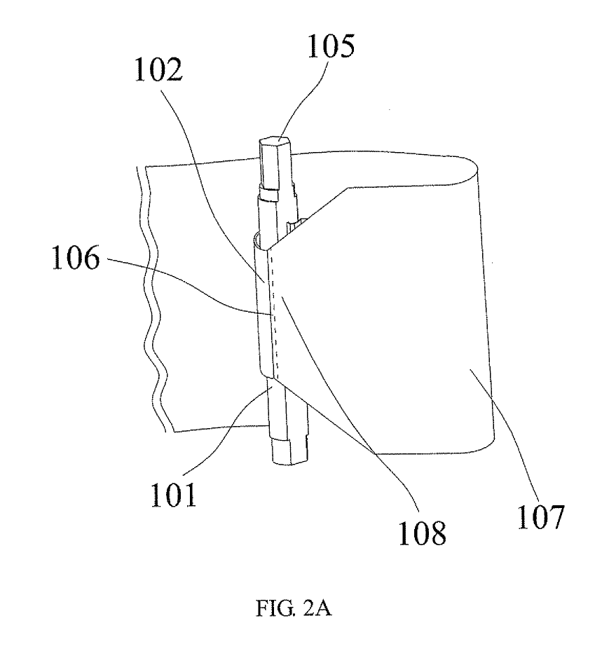

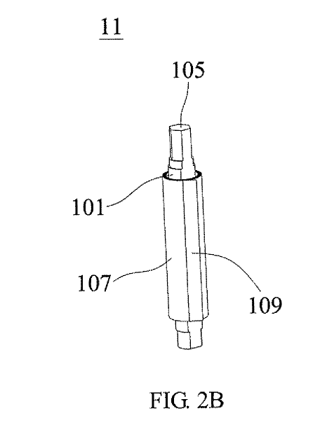

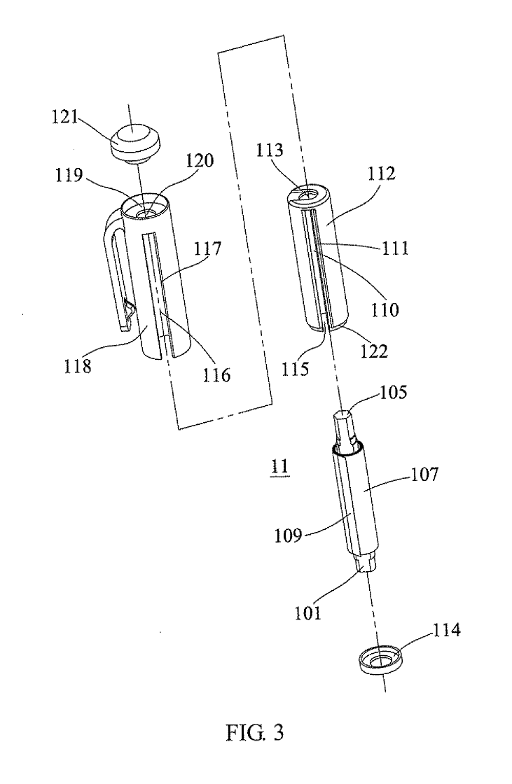

Please refer to FIG. 1 to FIG. 4. A spindle 101 is formed firstly, and the spindle 101 is a pillar component. A first end 103 of a flexible recovering component 102 having a resilient coefficient for recovering is fixed on a conjunction 104 of the spindle 101 for forming a flexible recovering component-spindle mechanism 10. The resilient recovering component 102 adjacent to the conjunction 104 stretches and becomes arc shape inside an accommodating space of a casing 112, so as to surround the spindle 101. The flexible recovering component 102 stretches to a final end of a second end 106, and the second end 106 is adhered for pasting function as shown in FIG. 1. In this embodiment, the flexible recovering component 102 is a resilient component, and the resilient component can be a metal thin component. It should be mentioned that a length of the resilient component 102 is smaller than a periphery of the spindle 101 when the flexible recovering component 102 is the resilient component. A flexible thin component 107 is disposed. A first end 108 of the flexible thin component 107 connects to the second end 106 of the flexible recovering component 102, and surrounds the spindle 101 including the flexible recovering component 102. The flexible thin component 107 rolls up to a final end of a second end 109 of the flexible thin component 107 for forming a flexible thin component-spindle mechanism 11. As shown in FIG. 2B, the flexible thin component 107 can be a paper, a soft piece, a plastic piece, a metal sheet, a cloth and so on. The flexible thin component-spindle mechanism 11 is disposed inside the casing 112 having an opening 110 and an inclined wall 111. It should be mentioned that an end 105 of the spindle 101 is exposed out of a hole 113 on a top surface of the casing 112. A bottom 114 is coupled to an opening 115 on a low area of the casing 112 for accommodating the flexible thin component-spindle mechanism 11. A pivot 112 is disposed on the low area of the casing 112 for supporting and rotating the low area of the spindle 101. When the flexible thin component 107 is curved and surrounds curvature radius of the spindle 101, an exposed part of the curved flexible thin component 107 contacts an inner surface of the casing 112. It should be mentioned that the second end 109 of the flexible thin component 107 is guided by the inclined wall 111 for contacting the inclined wall 111 when the second end 109 passes through the opening 110, so that the flexible thin component 107 can pierce through the opening 110. Then, the casing 112 can be disposed on a tube 118 including an opening 116 corresponding to the opening 110, and an inclined wall 117. The tube 118 recovers the casing 112, and the second end 109 passes through the opening 116 and is exposed out of the tube 118 by guiding of the inclined wall 117 via the opening 110, the inclined wall 111 and the corresponding opening 116. Furthermore, a spindle opening 120 is formed on a top portion 119 of the tube 118, and a portion 105 of the spindle 101 can pass outward the spindle opening 120. Then, a rotary component 121 is disposed on the top portion 119 of the tube 118 and connects to the exposed portion 105 of the spindle 101, so that the spindle 101 can be rotated for rolling in and rolling out the flexible thin component 107. After the flexible thin component 107 is rolled out, the flexible thin component 107 can be cut according to demand. The flexible recovering component 102 can be for fitting a space between the casing 112 and the spindle 101, so as to keep the flexible thin component contacting to an inner surface of the casing 112. Rolling device of the present invention is not limited to the above-mentioned embodiment, for example, the rolling device can be disposed inside the tube 118 or any other structure, and it depends on design demand.

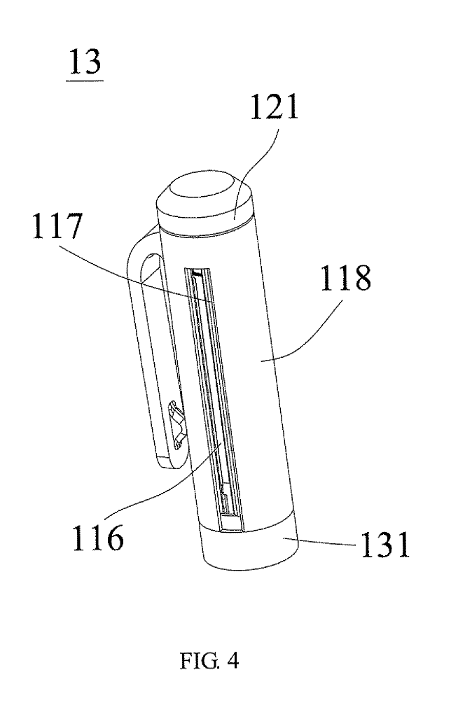

FIG. 4 is an assembly of the rolling device 13. a combining component 131 is coupled to the low end of the tube 118 for connecting the rolling device 13 to a tip component 14, so as to form the pen 15 having the rolling device.

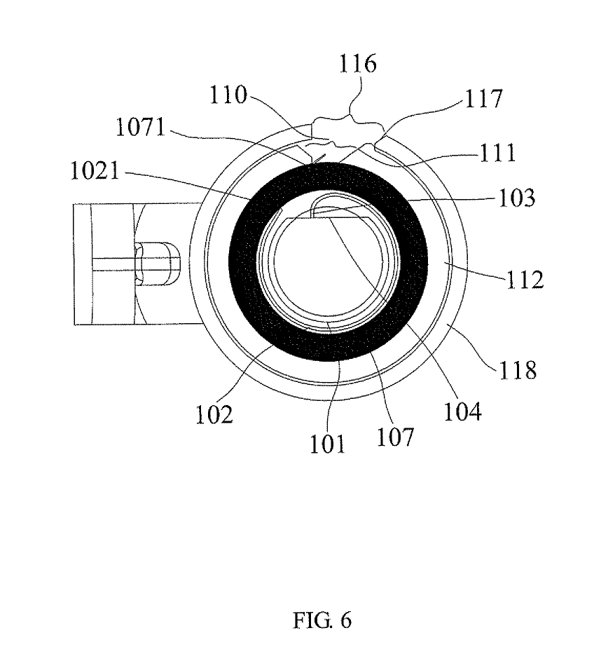

Please refer to FIG. 6, which shows a diagram of a side view of the rolling device. The first end 103 of the flexible recovering component 102 adjacent to the conjunction 104 stretches outwardly and surrounds the spindle 101 in a curved arc manner.

Application force of the spindle 101 includes a pulling force and a pushing force. The pushing force P1 points a direction of the application force for rolling out the flexible thin component 107, and the pulling force P2 points a direction of the application force for rolling in the flexible thin component 107. A description of the pushing force P1 is introduced as follows.

The flexible recovering component 102 has a curved recovering coefficient for transmitting a pulling force or a pushing force from a first end 103 of the flexible recovering component 102 to a second end 106 of the flexible recovering component 102. The flexible recovering component 102 can recover after forcing due to function of the curved recovering coefficient, and the curved recovering coefficient correspond to material of the flexible recovering component 102. A formula of the curved recovering coefficient is:

K=F/S

wherein K is the curved recovering coefficient of the flexible recovering component 102, F is effective application force of the flexible recovering component 102, and S is a displacement of the flexible recovering component 102. As k value is small, a huge displacement is generated by a small application force F, and the flexible recovering component 102 can recover without deformation. Because the deformation of the flexible recovering component 102 makes the rolling device ineffective, the curved recovering coefficient of the flexible recovering component 102 is equal to minimize curved recovering coefficient of the flexible recovering component 102 pushed by the application force without deformation. The curved recovering coefficient of the flexible recovering component 102 is greater than the minimize curved recovering coefficient of the flexible recovering component 102 for uniformly dispersing the pushing force P1 on a surface of the flexible recovering component 102, so as to generate uniform static friction and kinetic friction between the flexible recovering component 102 and the flexible thin component 107. The static friction and the kinetic friction generated by the curved recovering coefficient is smaller than or equal to the allowed pushing force (such as the allowed pushing force by a user) for rolling out the flexible thin component 107 effectively. The flexible recovering component 102 can be made by a group consisting of a tape, a plastic piece, a cardboard and so on. Therefore, a formula of the pushing force P1 by the user is as follows:

P1≧f1ₘₐₓ (1)

wherein f1ₘₐₓ is the max value of the static friction. Because the kinetic friction is usually greater than the max value of the static friction, the rolling device works as the pushing force is greater than the max value of the static friction. On the other word, as the formula (1) forms, the flexible thin component 107 can be pushed outward. When the front end 1071 of the flexible thin component 107 rotates at the opening 110, the front end 1071 is ejected out of the casing 112 by guiding of the inclined wall 111, and further is guided to pass through the opening 116 of the tube 118, so as to roll out a suitable length according to user demand. As the formula (1) does not work, the flexible thin component 107 can not be pushed outward. Material of the flexible recovering component 102 can be changed for decreasing the static friction and the kinetic friction, so as to decrease the pushing force P1 and to keep the function of the flexible thin component 107. It should be mentioned that the curved recovering coefficient of the flexible recovering component 102 can not too small for prevent the flexible recovering component 102 from deforming as rolling out. Deformation of the flexible recovering component 102 makes the rolling function ineffectively (the spindle 101 is rotated and the flexible thin component 107 can not be rolled out). The resilient coefficient of the flexible recovering component 102 is minimize resilient coefficient which makes the flexible recovering component 102 lost recovering function as pushing. Thus, loading intensity H of the curved recovering coefficient of the flexible recovering component 102 is as follows:

H≧f1ₘₐₓ (2)

On the other word, difference of each area on the flexible thin component 107 is limited within a range, which means the flexible thin component 107 is forced uniformly. As the difference of each area on the flexible thin component 107 is greater than a value, the flexible thin component 107 deforms or can not contact the inner surface of the casing 112, which makes the rolling device ineffectively. Therefore, the curved recovering coefficient of the flexible recovering component 102 is greater than a minimize curved recovering coefficient, so as to generate the uniform kinetic friction and uniform static friction between the flexible thin component 107 and the flexible recovering component 102.

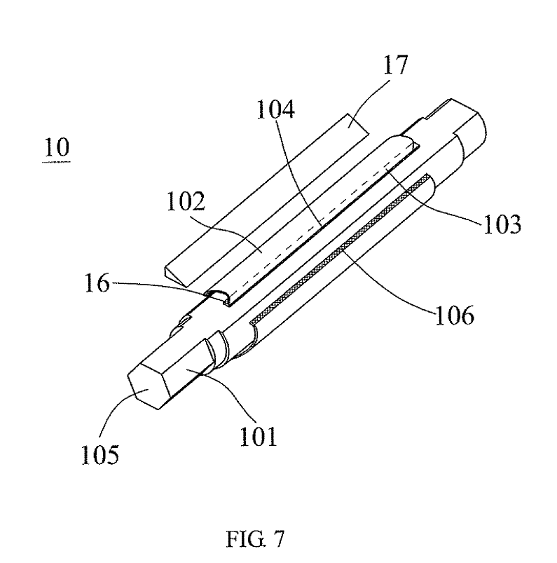

Please refer to the embodiment of the rolling device shown in FIG. 7. the flexible recovering component 102 can be made by the group consisting of the tape, the soft piece, the plastic piece, the cardboard and so on. As the flexible recovering component 102 is made by the above-mentioned material, a sunken part 16 is formed on the spindle 101 for accommodating the flexible recovering component 102, and a fixing component 17 is utilized to wedge inside the sunken part 16 for fixing the flexible recovering component 12 on the spindle 101, so as to strengthen the intensity. The flexible recovering component 102 can be adhered inside the sunken part 16.

As the flexible recovering component 102 is the resilient component (such as the metal thin component), the flexible recovering component 102 has the resilient coefficient for recovering, which means for contacting the exposed part of the curved flexible thin component 107 to the inner surface of the casing 112 when the flexible thin component 107 is rolled out according to the curvature radius of the spindle 101. The flexible thin component 107 can be force uniformly by constraining the length of the resilient component being smaller than the periphery of the spindle 101.

Furthermore, the casing 112 can be made by the material having low friction coefficient for decreasing the pushing force P1 by the user. Max static friction between the casing 112 and the flexible thin component 107 is smaller than or equal to the pushing force P1, and the pushing force P1 is smaller than or equal to the loading intensity H of the flexible recovering component 102 for preventing the flexible recovering component 102 from deforming. That is to say the above-mentioned situation is allowed according to the following formula:

f2ₘₐₓ≦P1≦H (3)

Material satisfying the formula (3) can be used for making the casing 112. For example, the casing can be made of plastic material having low friction coefficient.

The present invention has following advantages:
(1) The scrolling spring can be made easily.
(2) The length of the flexible recovering component is decreased, so that the manufacturing cost of the flexible recovering component is decreased. The insert molding method with high cost is unnecessary.
(3) Rolling invalidation of the flexible thin component can be solved effectively.

Those skilled in the art will readily observe that numerous modifications and alterations of the device and method may be made while retaining the teachings of the invention.

What is claimed is:

1. A rolling device comprising:
a spindle, the spindle being a pillar component;
a casing whereinside an accommodating space is formed, the spindle being disposed inside the casing, an end of the spindle being exposed out of the casing, and an opening being formed on the casing so that a flexible thin component injects into and ejects out of the casing via the opening;
a flexible recovering component, a first end of the flexible recovering component being fixed on the spindle, a second end of the flexible recovering component being fixed on the flexible thin component, the flexible recovering component having a curved recovering coefficient for transmitting a pulling force or a pushing force from the first end to the second end, the flexible recovering component being pushed without deformation according to the minimize curved recovering coefficient, and the curved recovering coefficient being greater than the minimize curved recovering coefficient which results the pulling force or the pulling force dispersing on a surface of the flexible recovering component uniformly, so as to generate uniform static friction and uniform kinetic friction between the flexible recovering component and the flexible thin component, and the uniform static friction and the uniform kinetic friction being smaller or equal to the pulling force and the pushing force, wherein the flexible recovering component is composed of a group consisting of a tape, a soft piece, a plastic piece or the cardboard; and
a rotary component externally disposed on a top of the casing with the spindle and connecting to the end of the spindle so as to rotate the spindle for injecting into or ejecting out of the flexible thin component.

2. The rolling device of claim 1, wherein a sunken part is formed on the spindle for accommodating the flexible recovering component, so as to fix the flexible recovering component on the surface of the spindle by wedging a fixing component into the sunken part.

3. The rolling device of claim 1, wherein the flexible thin component is a paper, a tape, a soft piece, a plastic piece, a metal sheet, or a cloth, and the casing is made of plastic material having low friction coefficient.

4. The rolling device of claim 1, wherein the rolling device is disposed on a top of a pen, the pen comprises a tube covering the casing, an opening and an inclined wall are formed on the tube corresponding to the opening of the casing, so that the flexible thin component is exposed out of the tube by the inclined wall when the flexible thin component passes through the opening, a spindle opening is formed on the top of the tube for exposing the end of the spindle, and a combining component is disposed on a bottom of the tube for combining with a tip component having a lead.

5. The rolling device of claim 1, wherein a shape of the flexible recovering component is a thin striped structure for fixing on the spindle, and a pivot is disposed on the bottom of the casing for supporting the bottom of the spindle and for rotating the spindle.

6. A rolling device comprising:
a spindle, the spindle being a pillar component;
a casing whereinside an accommodating space is formed, the spindle being disposed inside the casing, an end of the spindle being exposed out of the casing, and an opening being formed on the casing so that a flexible thin component injects into and ejects out of the casing via the opening;
a flexible recovering component, an end of the flexible recovering component being fixed on the spindle, the other end of the flexible recovering component being fixed on the flexible thin component, the flexible recovering component having a resilient coefficient for recovering, so that an exposed part of the curved flexible thin component contacts an inner surface of the casing when the flexible thin component is curved and surrounds curvature radius of the spindle, wherein the flexible recovering component is a resilient component, a first end of the resilient component connecting to a conjunction of the spindle and being fixed on the spindle, the resilient component surrounding around the spindle in a curved arc manner, and the resilient component stretching to the end of the second end of the resilient component, wherein a length of the resilient component is smaller than a periphery of the spindle, and the resilient component is a metal sheet; and
a rotary component externally disposed on a top of the casing with the spindle and connecting to the end of the spindle so as to rotate the spindle for injecting into or ejecting out of the flexible thin component.

7. The rolling device of claim 6, wherein the first end of the resilient component stretches outward by the conjunction and surrounds the spindle in the curved arc manner.

8. The rolling device of claim 6, wherein the flexible thin component is a paper, a tape, a soft piece, a plastic piece, a metal sheet, or a cloth, and the casing is made of plastic material having low friction coefficient.

9. The rolling device of claim 6, wherein a shape of the flexible recovering component is a thin striped structure for fixing on the spindle, and a pivot is disposed on the bottom of the casing for supporting the bottom of the spindle and for rotating the spindle.
